(19) United States
(12) Patent Application Publication
(10) Pub. No.: US 2014/0141891 A1
(43) Pub. Date: May 22, 2014

(54) CUSTOMIZABLE MOISTURE ABSORBING GAME CONTROLLER COVER

(71) Applicant: KARIM GEORGY, Orlando, FL (US)

(72) Inventor: KARIM GEORGY, Orlando, FL (US)

(21) Appl. No.: 14/083,534

(22) Filed: Nov. 19, 2013

Related U.S. Application Data
(60) Provisional application No. 61/728,939, filed on Nov. 21, 2012.

(51) Int. Cl. A63F 13/98

(52) U.S. Cl. CPC A63F 13/02
USPC 463/47

(57) ABSTRACT

A customizable moisture absorbing game controller cover includes a waterproof main body having a bottom half, and a top half that are joined together via a permanent seam along a first end and a removable seam along a second end. The top and bottom halves of the main body form a pocket into which a game controller can be housed. The main body includes a shape and dimension that is complementary to a particular game controller, and has a layered construction having a porous outer layer, a moisture absorbing middle layer and a waterproof inner layer. The controller cover also include a plurality of button nodules and/or joystick sleeves which are positioned along the main body at locations that correspond to the location of the buttons and/or joysticks of the game controller for which the device is intended to cover, and a plurality of removable markings securable to the main body at any location are provided.

### CROSS-REFERENCE TO RELATED APPLICATIONS

This application claims the benefit of U.S. Application Ser. No. 61/728,939 filed on 21 Nov. 2012, the contents of which are incorporated herein by reference.

### TECHNICAL FIELD

The present invention relates generally to the gaming industry, and more particularly to a moisture absorbing game controller cover which can be customized by a user.

### BACKGROUND

Video games are extremely addictive. Today's consumers can choose from thousands of different video games, which can be played on hundreds of different gaming systems, each having a plurality of different controllers. To this end, recent studies estimate that more than half a billion people worldwide play video games for at least one hour a day, and many “gamers” are known to play for multiple hours at a time.

In this regard, video game controllers can come in a wide variety of shapes and sizes, ranging from two handed controllers, single hand controllers, joysticks, steering wheels and the like. As such, many video game enthusiasts have a favorite controller which they use repeatedly whenever playing video games. The controller will often include markings and other such indicia the like which indicate the user's likes and interests.

Whether the user is a casual player or a hard core gamer, one problem faced by all revolves around sweat that constantly forms between the hands of the player and the game controller. In some instances, this is little more than a minor annoyance, which can be resolved by pausing the game and wiping the controller with a rag. However, when playing with others, pausing the game is not always an option, and attempting to wipe the controller during actual game play can result in dire consequences for the player's digital counterpart.

In addition to the above, some real world problems can be faced when consoles are saturated with sweat. For example, during live action games, the controller can slip from the player's hand causing physical damage to nearby equipment and/or injury to other players. Moreover, the controller itself can become damaged when the moisture seeps through the outer casing and affects the delicate internal parts. When damage occurs to the controller, the user must incur the expense of replacing it.

Accordingly, it would be beneficial to provide customizable moisture absorbing game controller cover that can enhance the video gaming experience of a user, without suffering from the above noted drawbacks.

### SUMMARY OF THE INVENTION

The present invention is directed to a customizable moisture absorbing game controller cover. One embodiment of the present invention can include a waterproof main body having a bottom half, and a top half that are joined together via a permanent seam along a first end and a removable seam along a second end. The top and bottom halves of the main body can form a pocket into which a game controller can be housed. The main body can take any number of different shapes and dimensions so as to fit a particular game controller, and can further include a layered construction having a porous outer layer, a moisture absorbing middle layer and a waterproof inner layer.

The controller cover can also include a plurality of button nodules and/or joystick sleeves which are positioned along the main body at locations that correspond to the location of the buttons and/or joysticks of the game controller for which the device is intended to cover.

Another embodiment of the present invention can include a plurality of removable markings which can be secured along the main body at any location that is desirable to a user.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1A is a front side view of a customizable moisture absorbing game controller cover, in accordance with one embodiment of the invention.

FIG. 1B is a back side view of the customizable moisture absorbing game controller cover, in accordance with one embodiment of the invention.

FIG. 2 is a partial cutout cross section view of a layered construction of the main body of the customizable moisture absorbing game controller cover, in accordance with one embodiment of the invention.

FIG. 3A is a front side view of the customizable moisture absorbing game controller cover, in accordance with another embodiment of the invention.

FIG. 3B is a back side view of the customizable moisture absorbing game controller cover, in accordance with another embodiment of the invention.

FIG. 4 is a front side view of the customizable moisture absorbing game controller cover with a plurality of removable markings, in accordance with one embodiment of the invention.

FIG. 5A is a front perspective view of the customizable moisture absorbing game controller cover in operation, and in accordance with one embodiment of the invention.

FIG. 5B is a back perspective view of the customizable moisture absorbing game controller cover in operation, and in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

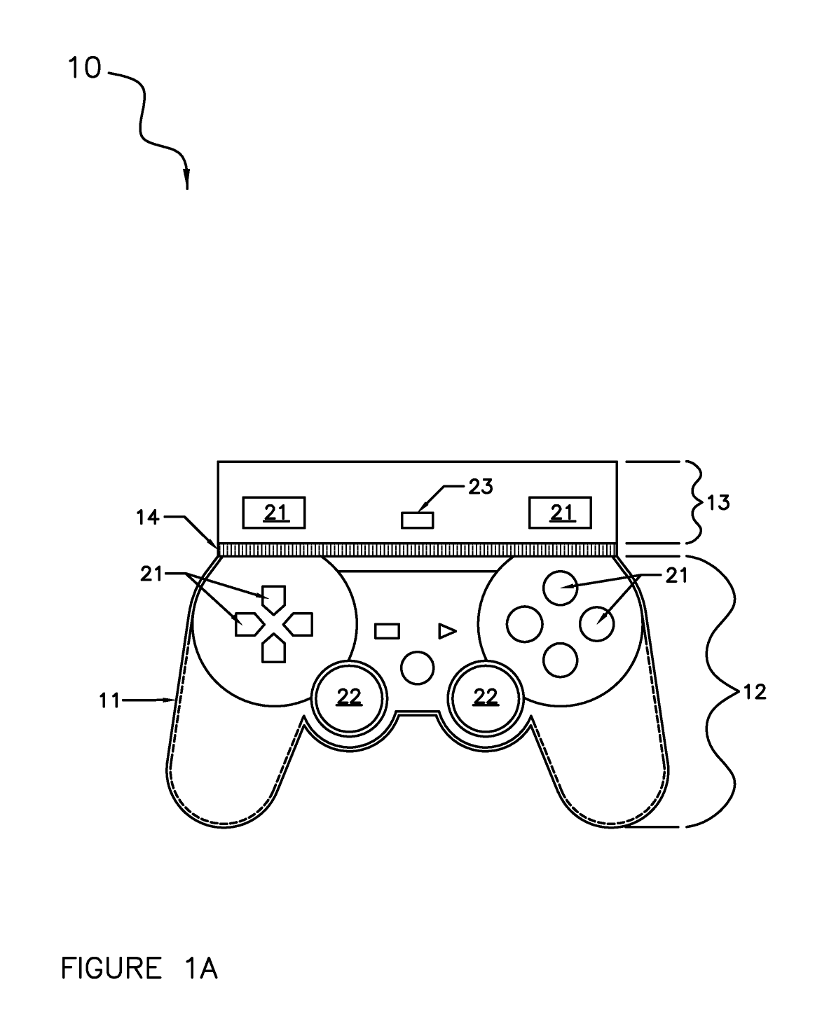

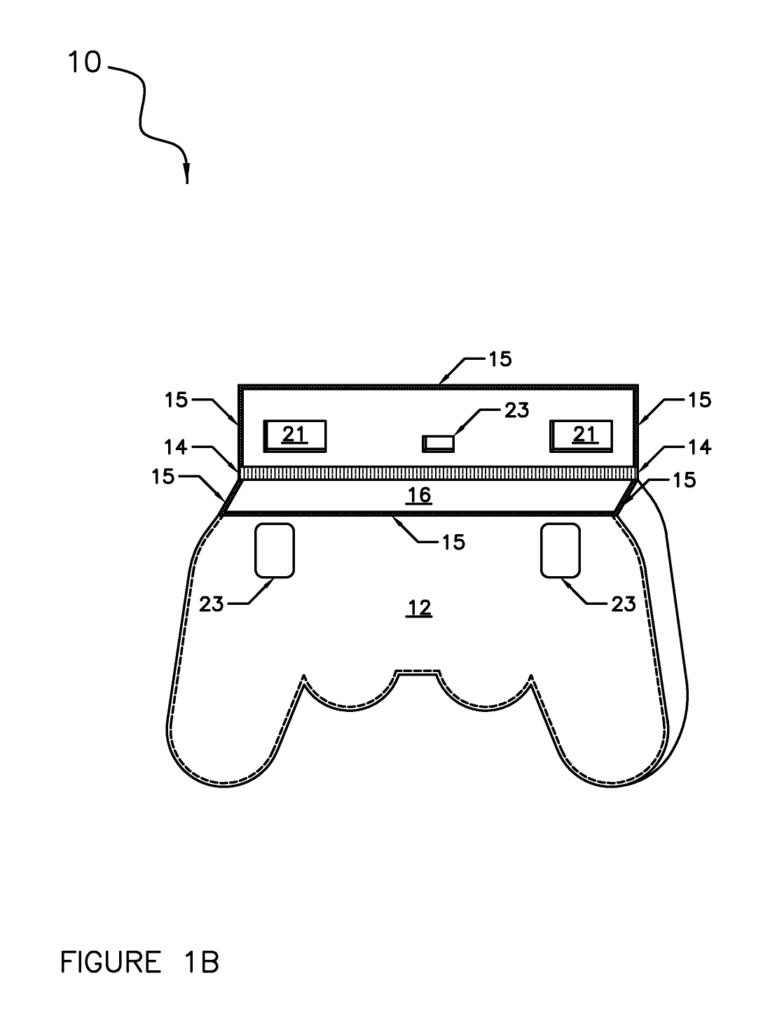

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

The illustrations presented throughout this document show the cover 10 sized and shaped for use with a single type of game controller. However, the illustrated examples are provided to show one possible embodiment of the invention, as those of skill in the art will recognize that the invention can be formed to function with any type of game controller regardless of size, shape, dimension and/or manufacturer without undue experimentation.

FIGS. 1A and 1B illustrate one embodiment of a customizable moisture absorbing game controller cover that is useful for understanding the inventive concepts disclosed herein. As shown, the controller cover 10 can include a main body having a size and shape that is constructed to securely cover a known video game controller.

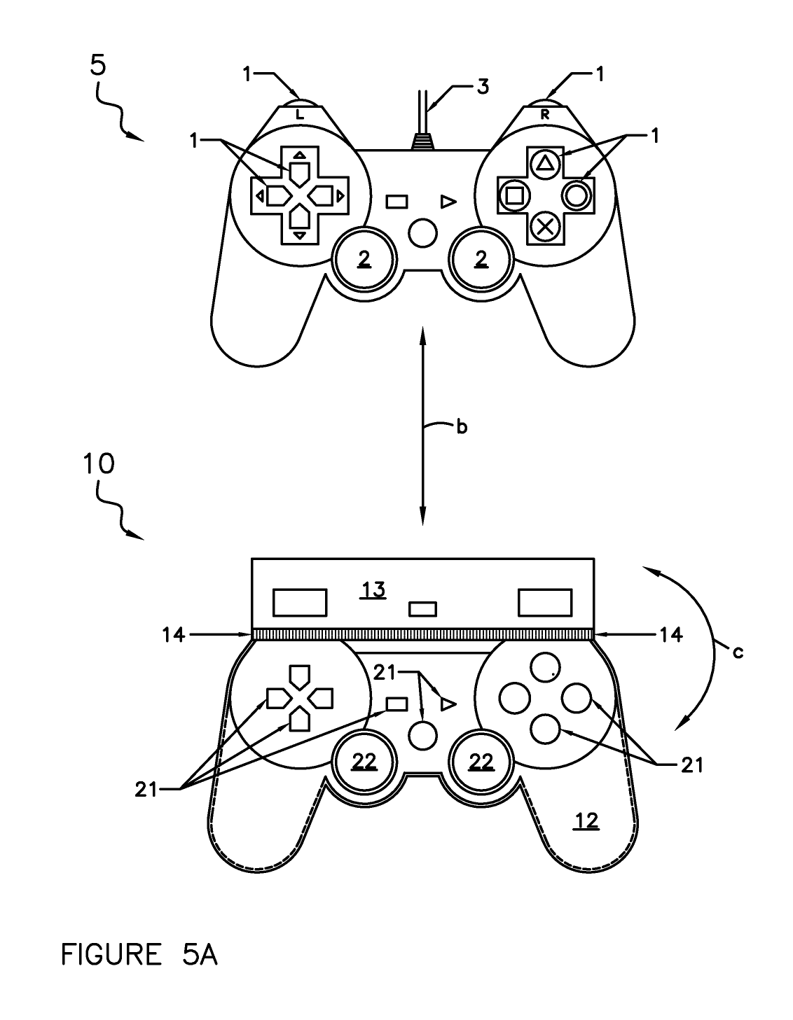

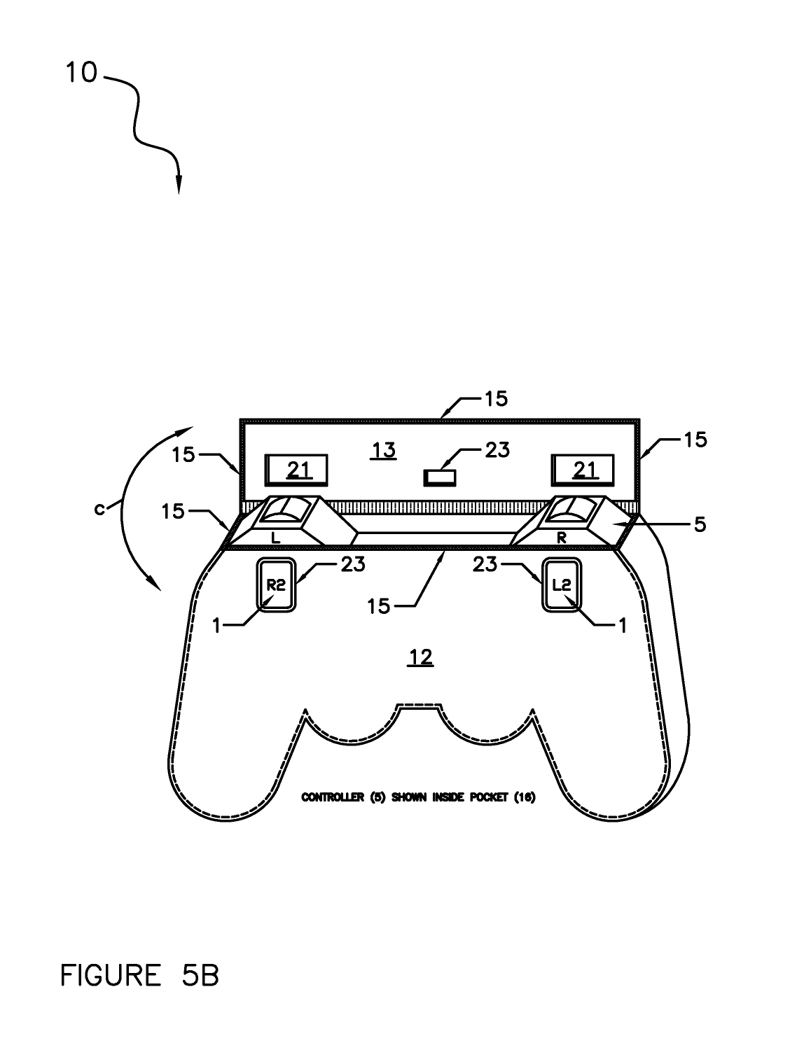

In one embodiment, the device 10 can include a main body 11 having a bottom half 12, and a top half 13, that are joined together via a permanent seam 14 along a first end, and a removable seam 15 along a second end. The top and bottom halves forming a pocket area 16 into which a game controller 5 can be housed (See FIG. 5). As described herein, the permanent seam 14 can include stitching or can be integral into the construction of the main body 11 itself. Likewise, the removable seam 15 can include any material capable of creating a temporary seal between two objects such as light adhesives, snaps, buttons, zippers, magnetic elements and/or opposing strips of hook and loop material (i.e., VELCRO), for example.

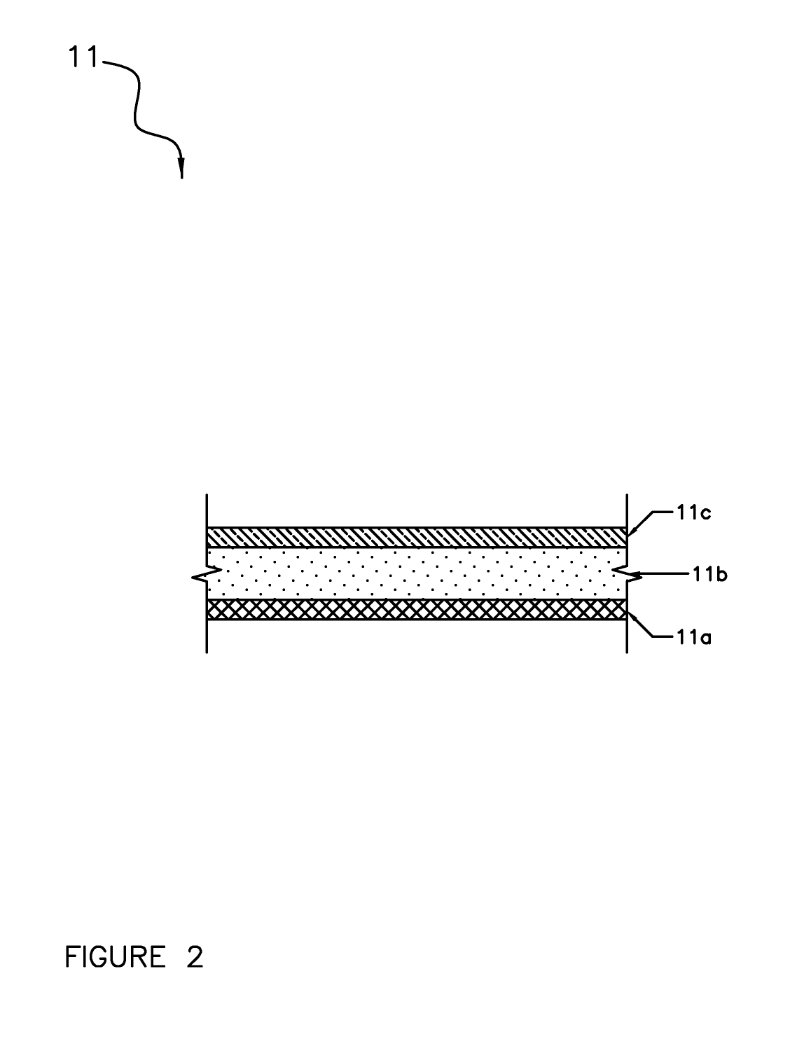

In one preferred embodiment, the main body 11 can include a layered construction, wherein each layer performs a different and specific function. As illustrated in cross sectional FIG. 2, the main body 11 can preferably include a moisture absorbing layer 11b that is interposed between a waterproof inner layer 11a and a soft outer layer 11c.

In one embodiment, inner layer 11a can be constructed from a waterproof material such as nylon, for example, which is extremely pliable and can prevent moisture from making contact with an inserted controller 5. The middle layer 11b can be constructed from any resilient material suitable for attracting moisture, such as blended cotton and/or foam, for example. Such a feature can function to actively remove moisture from the users' hand during game play, so as to provide a more enjoyable gaming experience. The outer layer 11c can preferably be constructed from a somewhat soft and porous material such as spandex/nylon blend, for example, which has an extremely high gripping capacity and can function to allow sweat from the users' hand to pass there through and be absorbed by the middle layer 11b.

Although described above with respect to particular materials, and three layers, other embodiments are contemplated utilizing a different number of layers and other materials, without limitation. For example, the main body 11 can also include a relatively firm construction material such as plastic, for example, that is covered with a rubber coating. Such a feature can function to protect the controller against impacts with foreign objects, while simultaneously remaining waterproof and providing excellent grip to the user.

As shown, the controller cover 10 can also include a plurality of button nodules 21 and/or joystick sleeves 22 at locations that correspond to the location of the buttons 1 and/or joystick(s) 2 of the game controller 5 for which the device 10 is intended to cover. These elements 21 and 22 can function to receive user inputs in order to operate the buttons and joystick(s) of the controller in a conventional manner, while preventing moisture from seeping onto the controller itself. Moreover, any number of different openings 23 can be provided through which a game controller cord 3 or a wireless transmitter, for example, can be located.

In the preferred embodiment, the nodules 21 and sleeves 22 can also be constructed from a soft and resilient material such as neoprene, cloth, and/or a spandex/nylon blend, for example. In this regard, the nodules 21 and sleeves 22 can be constructed from a material that is different from the main body itself, or can be constructed as integral components to the main body when each of the elements 21 and 22 are constructed from an identical material as the main body 11.

Although not illustrated, any number of markings can also be provided on one or more of the nodules 21 and sleeves 22. These markings can be identical to the markings found on the buttons of the game controller, or can be different. Additionally, alternate embodiments of the cover 10 are contemplated wherein one or more of the nodules 21 and/or sleeves 22 are absent, so as to allow the user to make direct contact with the buttons 1 and/or joystick(s) 2, themselves.

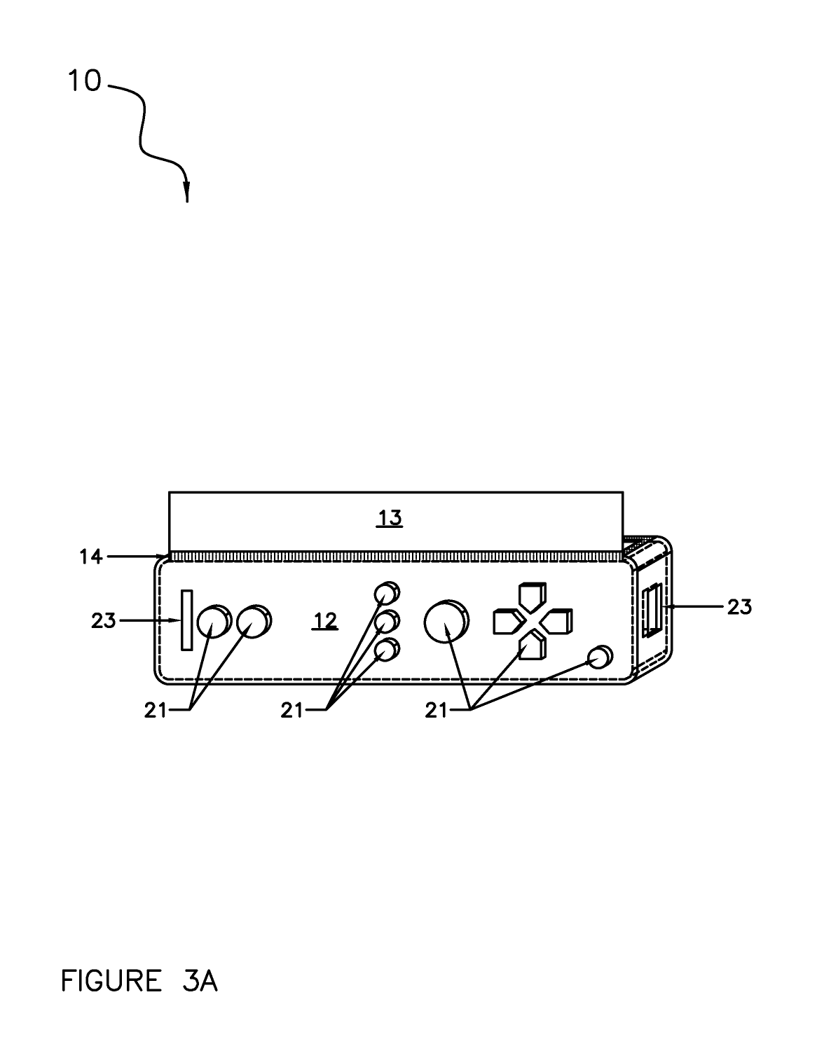

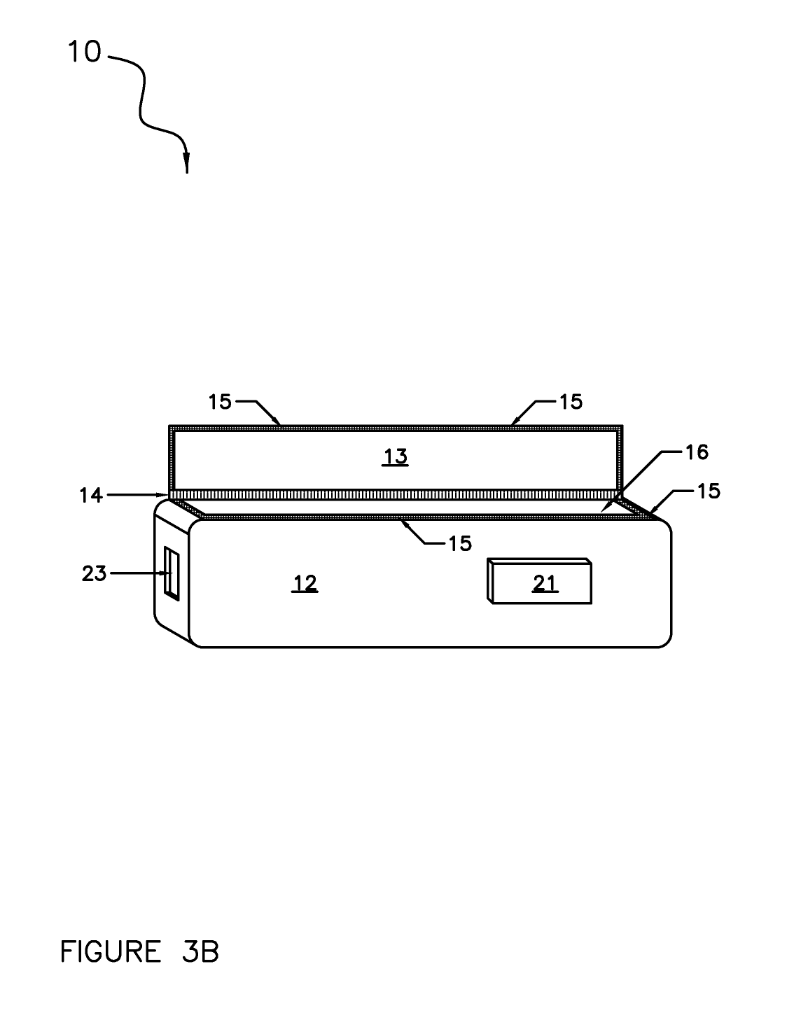

Although illustrated above as functioning with a dual joystick style controller, the inventive concepts described herein are not so limited. In this regard, FIGS. 3A and 3B, show the controller cover 10 having a shape and size that is constructed to receive a conventional motion stick controller. In this regard, the device 10 is not to be construed as limited to any particular type, brand or size controller device, and can be constructed to accommodate the features of any existing or conceptual game controller having an identifiable size, shape and interface configuration.

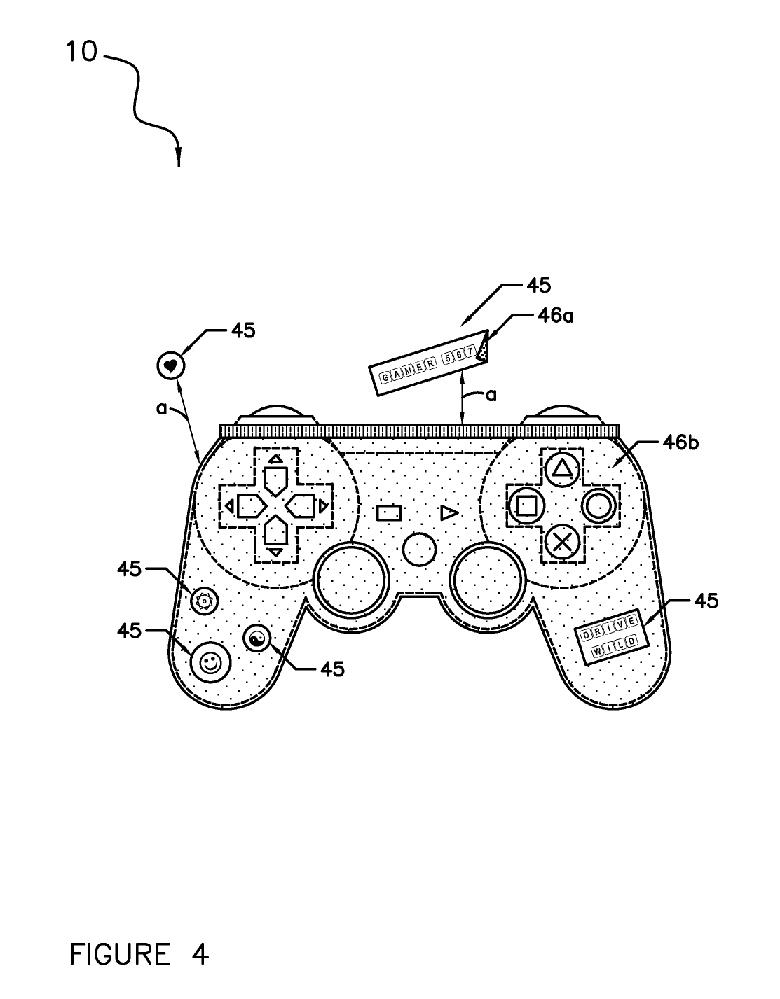

FIG. 4 illustrates another embodiment of the customizable moisture absorbing game controller cover 10 that further includes a plurality of removable markings 45. As shown by arrow a, each of the markings 45 can be removably secured to the main body of the cover 10. In this regard, each of the removable markings 45 can preferably include a main body having an unlimited number of indicia such as shapes, designs, characters, dimensions, geometric figures, characters, numbers, letters, words, colors and/or images, for example that are disposed along the front facing side. In one embodiment, each of the removable markings 45 can be constructed from a similar material to the main body, so as to absorb moisture and provide increased grip to the user.

In one embodiment, the back facing side of the indicia 45, and the outer surface of the controller cover 11c can each include opposing portions of hook and loop material 46a and 46b (e.g., VELCRO). In this regard, the outer surface 11c of the main body can be constructed from the soft loop portion, and the indicia 45 can include the rougher hook elements. Such a feature can allow each of the removable indicia 45 to be secured onto the main body 11 of the controller 10 at any location, and in any manner desirable to the user.

Although illustrated as being integral to the construction of the main body, other embodiments are also contemplated wherein the hook and loop material is located only in specific areas. Moreover, those of skill in the art will recognize that any number of other connectors capable of creating a removable attachment between two surfaces can be substituted for the hook and loop material 46 described above. Moreover, although described above as removable in nature, other embodiments wherein users can permanently adhere the markings to the controller cover are also contemplated.

FIGS. 5A and 5B illustrate one embodiment of the controller cover 10 in operation with a conventional game controller 5. As shown, the controller 5 can be inserted into the pocket created by the bottom half 12 of the controller cover (See arrow B). At this time, the buttons 1 and joysticks 2 can be aligned with the button nodules 21 and the joystick sleeves 22, respectively, and the removable seam 15 along the back side of the cover can be engaged, as shown by arrow c. Finally, any number of indicia can be secured onto the cover body and the device is ready for use.

Accordingly, the customizable moisture absorbing game controller cover 10 can be customized to the particular interests of a user, while functioning to actively remove moisture from the users' hands during game play, thereby providing additional grip and damage prevention to an inserted game controller 5.

As described herein, one or more elements of the moisture absorbing game controller cover 10 can be secured together utilizing any number of known attachment means such as, for example, adhesives, industrial stitching, and seam tape, among others. Moreover, although the above embodiments have been described as including separate individual elements, the inventive concepts disclosed herein are not so limiting. To this end, one of skill in the art will recognize that one or more individual elements such as the lower half 12, the upper half 13, the permanent seam 14, the button nodules 21 and/or joystick sleeves 22, for example, may be formed together as one continuous element, either through manufacturing processes, such as molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A video game controller cover, said cover comprising:
a waterproof main body having a bottom section and a top section that are permanently joined along a first side, and removably joined along a second side, said top and bottom sections forming a pocket for receiving a video game controller having a known shape and dimension;
a plurality of button nodules disposed along the main body, each of said nodules being constructed from a resilient waterproof material and functioning to engage a button on an inserted game controller; and
an opening positioned along the main body, said opening functioning to accommodate at least one of a cord and a wireless transmitter.

2. The cover of claim 1, wherein the main body includes a layered construction consisting of a moisture absorbing middle layer that is interposed between a waterproof inner layer and a soft, porous outer layer.

3. The cover of claim 1, further comprising:
at least one joystick sleeve, said sleeve including a shape and size that is complementary to a joystick located on an inserted game controller, said sleeve being constructed from a resilient waterproof material.

4. The cover of claim 1, wherein each of the plurality of button nodules and at least one joystick sleeve are constructed as from an identical material to the main body and as integrated elements of the main body.

5. The cover of claim 1, wherein each of the plurality of button nodules and at least one joystick sleeve are constructed a different material than the main body.

6. The cover of claim 1, further comprising:
a plurality of removable markings each consisting of a main body having a front facing surface that includes indicia, and a rear facing surface that includes a connector for mating with the main body of the cover.

7. The cover of claim 6, wherein an outer surface of the main body includes a plurality of soft loop portions and each of the removable markings include connectors that are constructed from hook elements, said hook and loop elements function to create a bond between the markings and the main body.
